(19) United States
(12) Patent Application Publication
(10) Pub. No.: US 2019/0191044 A1
(43) Pub. Date: Jun. 20, 2019

(54) PANEL TRANSLATION SERVICE

(71) Applicant: KYOCERA Document Solutions Inc., Osaka (JP)

(72) Inventors: Ranjit Ghodke, Fremont, CA (US); Dilinur Wushour, Clayton, CA (US)

(21) Appl. No.: 15/842,690

(22) Filed: Dec. 14, 2017

(51) Int. Cl. H04N 1/00; G06F 3/0484; G06F 17/28; G06K 9/18

(52) U.S. Cl. CPC H04N 1/00498; G06F 3/0484; G06F 17/289; G06K 9/18; H04N 2201/0094; H04N 1/00411; H04N 1/00344; H04N 1/00236; H04N 1/00251

(57) ABSTRACT

An image capture device such as a multi-function printer may identify the language of a document and automatically select a language configuration with predetermined settings. The language configuration may be applied to the image capture device automatically, or a user may be prompted to set or accept the language configuration. In some cases, analysis of the language may be performed using a cloud based service. In some cases, a translation of the document or parts of the document may be performed.

### BACKGROUND OF THE INVENTION

### 1. Field of the Invention

The present invention relates generally to setting a language configuration, and more specifically to setting a language configuration of a printing device based on a source document.

### 2. Discussion of the Related Art

Various systems and processes are known in the art for capturing and generating images (e.g., printers, copiers and multi-function printing devices). In some cases, such devices may be capable of recognizing and displaying text. However, many languages may be used in an office environment, and image capture devices may have a variety of language settings.

In some cases, users may set the language settings manually from an operation panel of the printer system. However, users may experience difficulty operating a printer system that does not have the same language settings they are accustomed to. Furthermore, setting a language configuration manually may result in errors or inefficiency.

### SUMMARY

Several embodiments of the invention advantageously address the needs above as well as other needs by providing a method for displaying information on a display, comprising: imaging textual information using an image capture device; performing optical character recognition on the textual information having been imaged; determining a language of the textual information having been optically character recognized; and displaying predetermined display information as a function of the language having been determined.

In another embodiment, the invention can be characterized as a system comprising: an image capture device, wherein the image capture device is configured to capture an image; an optical character recognizer coupled to the image capture device, wherein the optical character recognizer is configured to recognize textual information in the image; a language identifier coupled to the optical character recognizer, wherein the language identifier is configured to identify a language of the textual information; a memory containing predetermined display information coupled to the language identifier; and a display, wherein the display retrieves the predetermined display information from the memory and displays the predetermined display information as a function of the language identified by the language identifier.

In yet another embodiment, the invention may be characterized as an apparatus comprising: an optical character recognizer coupled to an image capture device, wherein the optical character recognizer is configured to recognize textual information in the image; a language identifier coupled to the optical character recognizer, wherein the language identifier is configured to identify a language of the textual information; a memory containing predetermined display information coupled to the language identifier; and a display, wherein the display retrieves the predetermined display information from the memory and displays the predetermined display information as a function of the language identified by the language identifier.

### BRIEF DESCRIPTION OF THE DRAWINGS

FIG. 1 shows a diagram of an image capture system that supports setting a language configuration of a printing device based on a source document in accordance with aspects of the present disclosure.

FIG. 2 shows a diagram of an image capture device that supports setting a language configuration of a printing device based on a source document in accordance with aspects of the present disclosure.

FIG. 3 shows a sequence diagram of a process for setting a language configuration of a printing device based on a source document in accordance with aspects of the present disclosure.

FIGS. 4 through 9 show flowcharts of processes for setting a language configuration of a printing device based on a source document in accordance with aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention.

Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

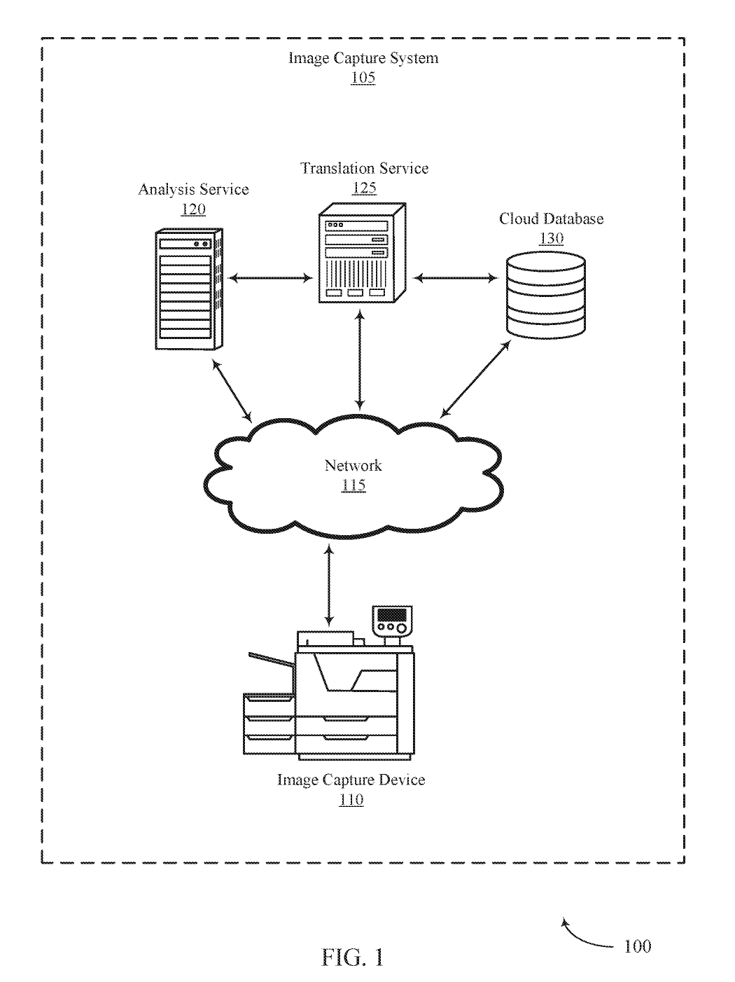

FIG. 1 shows a diagram 100 of an image capture system 105 that supports setting a language configuration of a printing device based on a source document in accordance with aspects of the present disclosure. In some examples, image capture system 105 may include image capture device 110, network 115, analysis service 120, translation service 125, and cloud database 130.

Many languages may be used in an office environment. Technologies utilizing language in their user interfaces may include printers and printing systems. In some cases, users may find difficulty operating a printer system that does not have the same language settings they are used to. Users may sometimes have to set the language manually from an operation panel of the printer system.

The described system enables an image capture device 110 to automatically clone language setting configurations by using a source document. Communicating with a user in their native language may create a more personalized feel and experience. User languages may include Mandarin, Spanish, Russian, and Japanese.

Translating between languages may facilitate product globalization and familiarity, ease of access, technological advancement and future-proofing.

In some examples, the image capture system 105 may enable efficient translation for image capture devices 110. The service may first detect the language a user wants the image capture device 110 to operate in. This may be done through scanning a source document, or through manual operation by the user. In some example embodiments, the user may also speak in their native language to determine the operating language. Once the source document has been scanned, the image data may be sent to the analysis service 120.

The analysis service 120 may then send the image data to a translation service 125 to determine the language of the image. The translation service 125 may run an optical character recognizer to extract text data from the image data. If the cloud database 130 already has a translated dictionary for the input language, the dictionary may be sent back to the image capture device 110. If the servers do not have the translated dictionary, the servers may utilize the translation service 125 to translate a baseline English dictionary to the language of the source document. This newly translated dictionary may then be stored on the cloud database 130 for future use, and also sent to the image capture device 110 where the user may now select to finish the transaction in his or her native language.

In one example, an image capture device 110 exists at an airport with an operating panel in the English language. A visitor from India may scan his ticket in the image capture device 110. The image capture device 110 may then use the optical character recognizer to detect the language from the ticket and reach out to the cloud database 130 to check for a Hindi dictionary. In this example, the Hindi dictionary does not yet exist on the cloud database 130, so the servers will utilize the translation service 125 for translation. The translated dictionary may then be returned to the image capture device 110, and the user may then be prompted to change the language of the image capture device 110 to Hindi. In some embodiments, predetermined display information (display elements designated for language updating) is used to determine text and/or images that are updated based on the language of the image capture.

In another example, an image capture device 110 exists at an office with an English panel. In the office, a visitor from Japan attempts to use the image capture device 110. When the visitor scans a document, the image capture device 110 detects the language of the document to be Japanese. Upon detecting the source language, the image capture device 110 may then reach out to the cloud database 130 to check for a Japanese dictionary. Upon finding an existing Japanese dictionary, the image capture device 110 may then accept the dictionary from the cloud database 130 and prompt the user to finish her transaction in Japanese.

The image capture device 110 may provide internet connectivity, the ability to display strings from a database, as well as scanning and printing operations.

The cloud database 130 and analysis service 120 provide database storage, string mapping, and the ability to send strings to the image capture device 110. In some cases, the translation service 125 may provide the optical character recognizer. In other examples, image capture device 110 may provide the optical character recognizer.

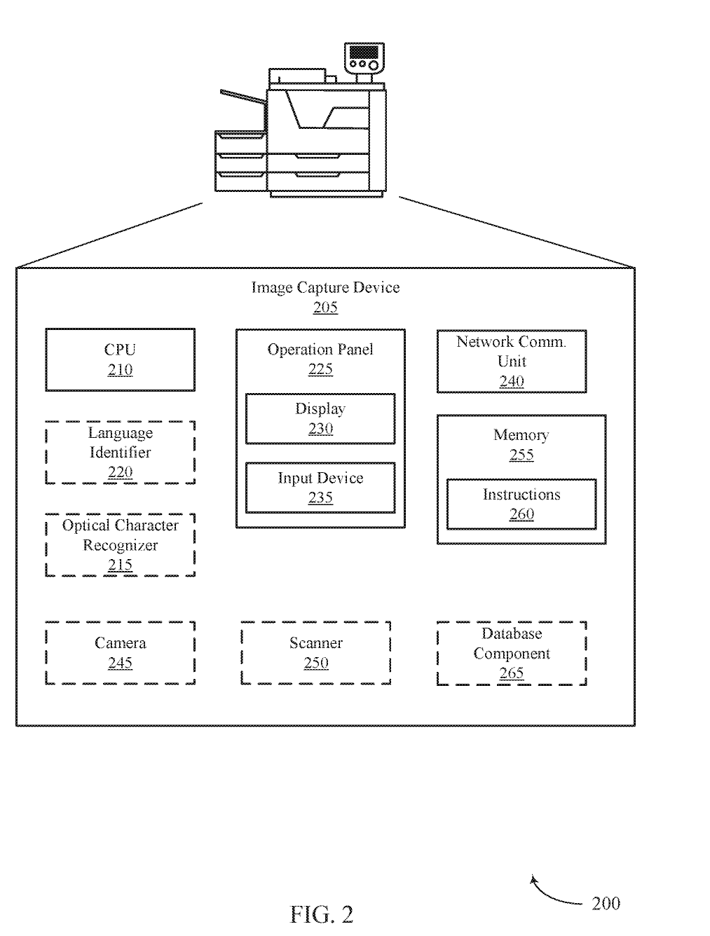

Image capture device 110 may image textual information using an imaging device and be an example of a component. Image capture device 110 may incorporate aspects of image capture device 205 as described with reference to FIG. 2.

In some examples, setting configurations for the image capture device 110 may be determined by analysis performed by other apparatuses (i.e., servers connected to the image capture device 110 through network 115). In further examples, language setting configurations for an image capture device 110 may be determined by an analysis service, which may include a translation service and a database.

The image capture device 110 may include a network 115 communication unit. The network communication unit can establish a network communication, such as a wireless or wired connection with the other one or more image capture devices 110 and the server device, in the image capture device 110 according to the present invention.

In some examples, analysis service 120 may identify a language used in a source document and translation service 125 may translate predetermined display information into the language having been determined. For example, the predetermined display information may have been previously designated to include the text displayed on a screen. The analysis service 120 would then translate the text into the language having been determined. The image capture device 110 would, after receiving the translated text, update the display to show the translated text in the language having been determined.

FIG. 2 shows a diagram 200 of an image capture device 205 that supports setting a language configuration of a printing device based on a source document in accordance with aspects of the present disclosure. Image capture device 205 may image textual information using an imaging device. Image capture device 205 may incorporate aspects of image capture device 110 as described with reference to FIG. 1. In some examples, image capture device 205 may include central processing unit (CPU) 210, optical character recognizer 215, language identifier 220, operation panel 225, network communication unit 240, camera 245, scanner 250, memory 255, and database component 265.

In some examples, image capture device 205 may be a printing device or a multi-function system including a scanner 250 and one or more functions of a copier, a facsimile device, and a printer. The image capture device 205 may further include an operation panel 225, a finisher (not shown) and one or more paper cassettes (not shown).

In one example of an image capture device 205, the memory 255 component may store instructions 260, which are executable by the CPU 210 and/or any other processor(s). The memory 255 component may also store information for various programs and applications, as well as data specific to the image capture device 205. For example, the data storage may include data for running an operating system (OS). The memory 255 component may include both volatile memory and non-volatile memory. Volatile memory may include random access memory (RAM). Some examples of non-volatile memory 255 include read only memory (ROM), flash memory, electronically erasable programmable read only memory (EEPROM), digital tape, a hard disk drive (HDD), and a solid state drive (SSD).

The memory 255 component may include any combination of readable and/or writable volatile memories and/or non-volatile memories, along with other possible memory 255 devices. Processor(s) including the CPU 210 may include one or more processors capable of executing instructions 260, such as instructions 260 which cause the image capture device 205 to perform various operations.

The processor(s) may also incorporate processing components for specific purposes, such as application-specific integrated circuit (ASICs) and field-programmable gate array (FPGAs). Other processors may also be included for executing operations particular to the image capture device 205. The operation panel 225 may include a display 230 component and an input component for facilitating human interaction with the image capture device 205. The display 230 component may be any electronic video display 230, such as a liquid-crystal display (LCD).

The input component may include any combination of devices that allow users to input information into the operation panel 225, such as buttons, a keyboard, switches, and/or dials. In addition, the input component may include a touch-screen digitizer overlaid onto the display 230 component that can sense touch and interact with the display 230 component.

The image capture device 205 may include a network communication unit 240. The network communication unit 240 can establish a network communication, wireless or wired, with the other one or more image capture devices 205 and server devices in an image capture system according to the present invention.

Optical character recognizer 215 may perform optical character recognition on the textual information having been imaged and be an example of a component coupled to the image capture device 205, where the optical character recognizer 215 is configured to recognize textual information in the image. Optical character recognizer 215 may be located within image capture device 205 or on a network server.

Language identifier 220 may determine a language of the textual information having been optically character recognized and be an example of a component coupled to the optical character recognizer 215, where the language identifier 220 is configured to identify a language of the textual information. Language identifier 220 may be located within image capture device 205 or on a network server.

In some examples, operation panel 225 may include display 230 and input device 235. Display 230 may display predetermined information as a function of the language having been determined; prompt a user in response to the determining the language to provide a user input; and display the predetermined display information as a function of the language having been transmitted.

In some cases, displaying predetermined information is in response to the receiving the user input. In some cases, prompting the user comprises displaying the language having been determined to the user and requesting that the user confirm the language having been determined. In some cases, the display 230 displays a confirmation prompt in response to the language having been identified by the language identifier 220, where the input device 235 receives a confirmation input in response to the confirmation prompt, and where the display 230 displays the predetermined display information as a function of the language identified by the language identifier 220 and the confirmation input received by the input device 235.

Input device 235 may be an example of a component coupled to the memory 255, where the input device 235 is a touch screen. Network communication unit 240 perform network communications. For example, network communication unit 240 may receive the user input in response to the prompting of the user and transmit a language signal as a function of the language of the textual information having been determined over a network.

In some cases, the image capture device 205 comprises a camera 24a. In some cases, the image capture device 205 comprises a scanner 250.

Memory 255 may be coupled to the language identifier 220. In some examples, memory 255 may include instructions 260. In some examples, memory 255 may include database component 265. In other examples database component 265 communicates with an external device to retrieve database information.

The database component 265 in some embodiments maintains a database including the predetermined display information in at least two languages. The database component 265 may in some embodiments retrieve predetermined display information from an external database of display information, where the retrieved predetermined display information is in at least two languages. In some embodiments the external device is cloud database 130. In some cases, the retrieving comprises transmitting a request for the predetermined display information via a network receiving the predetermined display information via the network.

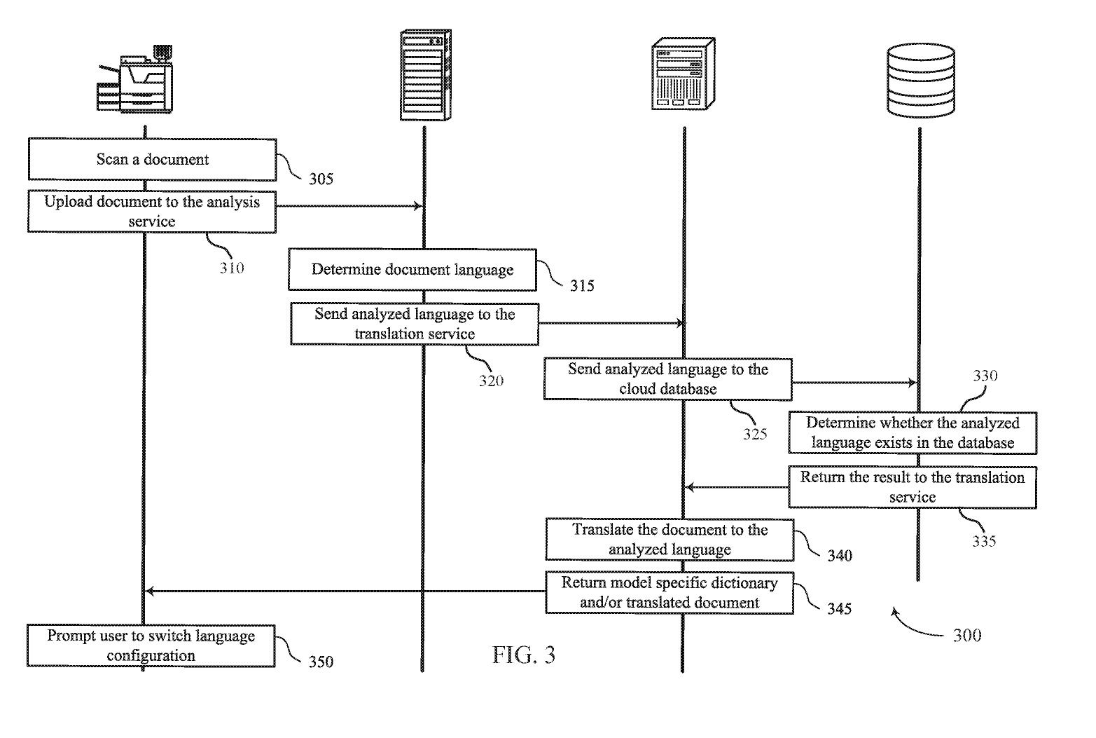

FIG. 3 shows a sequence diagram 300 of a process for setting a language configuration of a printing device based on a source document in accordance with aspects of the present disclosure. In some examples, an image capture system may execute a set of codes to control functional elements of the image capture system to perform the described functions. Additionally, or alternatively, an image capture system may use special-purpose hardware.

At block 305 the image capture system may scan a document. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 310 the image capture system may upload document to the analysis service. These operations may be performed according to the methods and processes described in accordance with aspects of the present disclosure. For example, the operations may be composed of various substeps, or may be performed in conjunction with other operations described herein. In certain examples, aspects of the described operations may be performed by network communication unit 240 as described with reference to FIG. 2.

At block 315 the image capture system may determine document language. These operations may be performed according to the methods and processes described in accordance with aspects of the present disclosure. For example, the operations may be composed of various substeps, or may be performed in conjunction with other operations described herein. In certain examples, aspects of the described operations may be performed by analysis service 120 as described with reference to FIG. 1.

At block 320 the image capture system may send analyzed language to the translation service. These operations may be performed according to the methods and processes described in accordance with aspects of the present disclosure. For example, the operations may be composed of various substeps, or may be performed in conjunction with other operations described herein. In certain examples, aspects of the described operations may be performed by analysis service 120 as described with reference to FIG. 1.

At block 325 the image capture system may send analyzed language to the cloud database. These operations may be performed according to the methods and processes described in accordance with aspects of the present disclosure. For example, the operations may be composed of various substeps, or may be performed in conjunction with other operations described herein. In certain examples, aspects of the described operations may be performed by translation service 125 as described with reference to FIG. 1.

At block 330 the image capture system may determine whether the analyzed language exists in the database. These operations may be performed according to the methods and processes described in accordance with aspects of the present disclosure. For example, the operations may be composed of various substeps, or may be performed in conjunction with other operations described herein. In certain examples, aspects of the described operations may be performed by cloud database 130 as described with reference to FIG. 1.

At block 335 the image capture system may return the result to the translation service. These operations may be performed according to the methods and processes described in accordance with aspects of the present disclosure. For example, the operations may be composed of various substeps, or may be performed in conjunction with other operations described herein. In certain examples, aspects of the described operations may be performed by cloud database 130 as described with reference to FIG. 1.

At block 340 the image capture system may optionally translate the document to the analyzed language. These operations may be performed according to the methods and processes described in accordance with aspects of the present disclosure. For example, the operations may be composed of various substeps, or may be performed in conjunction with other operations described herein. In certain examples, aspects of the described operations may be performed by translation service 125 as described with reference to FIG. 1.

At block 345 the image capture system may return model specific dictionary and/or translated document. These operations may be performed according to the methods and processes described in accordance with aspects of the present disclosure. For example, the operations may be composed of various substeps, or may be performed in conjunction with other operations described herein. In certain examples, aspects of the described operations may be performed by translation service 125 as described with reference to FIG. 1.

At block 350 the image capture system may prompt user to switch language configuration. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

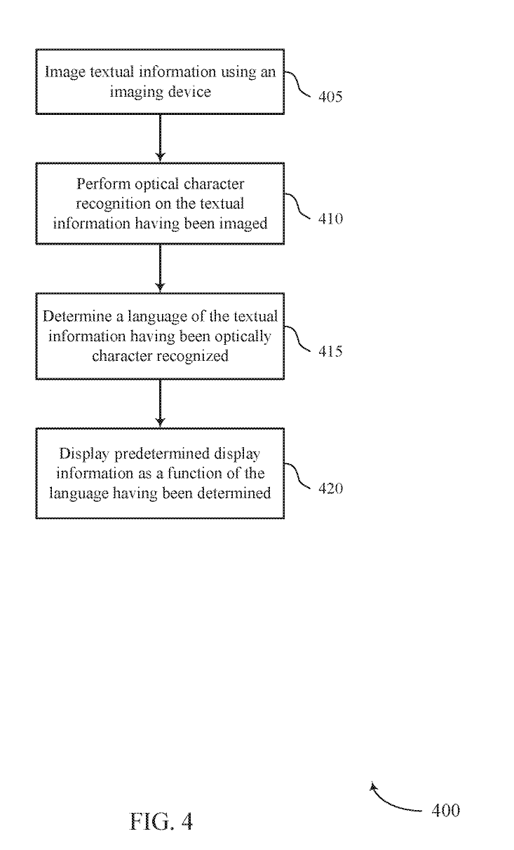

FIG. 4 shows a flowchart 400 of a process for setting a language configuration of a printing device based on a source document in accordance with aspects of the present disclosure. In some examples, an image capture device may execute a set of codes to control functional elements of the image capture device to perform the described functions. Additionally, or alternatively, an image capture device may use special-purpose hardware.

At block 405 the image capture device may image textual information using an imaging device. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 410 the image capture device may perform optical character recognition on the textual information having been imaged. These operations may be performed according to the methods and processes described in accordance with aspects of the present disclosure. For example, the operations may be composed of various substeps, or may be performed in conjunction with other operations described herein. In certain examples, aspects of the described operations may be performed by optical character recognizer 215 as described with reference to FIG. 2. In some cases, this function may be performed by an external device connected to the image capture device via a network connection.

At block 415 the image capture device may determine a language of the textual information having been optically character recognized. These operations may be performed according to the methods and processes described in accordance with aspects of the present disclosure. For example, the operations may be composed of various substeps, or may be performed in conjunction with other operations described herein. In certain examples, aspects of the described operations may be performed by language identifier 220 as described with reference to FIG. 2. In some cases, this function may be performed by an external device connected to the image capture device via a network connection.

At block 420 the image capture device may display predetermined display information as a function of the language having been determined. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

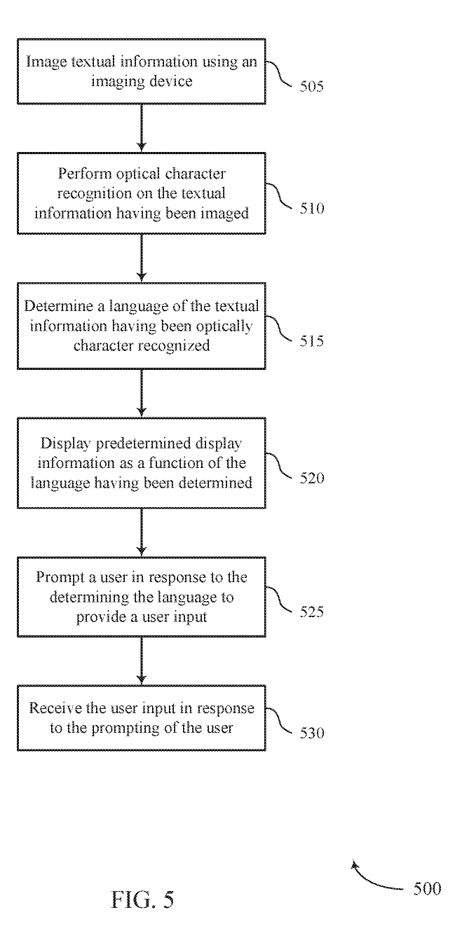

FIG. 5 shows a flowchart 500 of a process for setting a language configuration of a printing device based on a source document in accordance with aspects of the present disclosure. In some examples, an image capture device may execute a set of codes to control functional elements of the image capture device to perform the described functions. Additionally, or alternatively, an image capture device may use special-purpose hardware.

At block 505 the image capture device may image textual information using an imaging device. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 510 the image capture device may perform optical character recognition on the textual information having been imaged. These operations may be performed according to the methods and processes described in accordance with aspects of the present disclosure. For example, the operations may be composed of various substeps, or may be performed in conjunction with other operations described herein. In certain examples, aspects of the described operations may be performed by optical character recognizer 215 as described with reference to FIG. 2. In some cases, this function may be performed by an external device connected to the image capture device via a network connection.

At block 515 the image capture device may determine a language of the textual information having been optically character recognized. These operations may be performed according to the methods and processes described in accordance with aspects of the present disclosure. For example, the operations may be composed of various substeps, or may be performed in conjunction with other operations described herein. In certain examples, aspects of the described operations may be performed by language identifier 220 as described with reference to FIG. 2. In some cases, this function may be performed by an external device connected to the image capture device via a network connection.

At block 520 the image capture device may display predetermined display information as a function of the language having been determined. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

At block 525 the image capture device may prompt a user in response to the determining the language to provide a user input. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

At block 530 the image capture device may receive the user input in response to the prompting of the user. These operations may be performed according to the methods and processes described in accordance with aspects of the present disclosure. For example, the operations may be composed of various substeps, or may be performed in conjunction with other operations described herein. In certain examples, aspects of the described operations may be performed by network communication unit 240 as described with reference to FIG. 2.

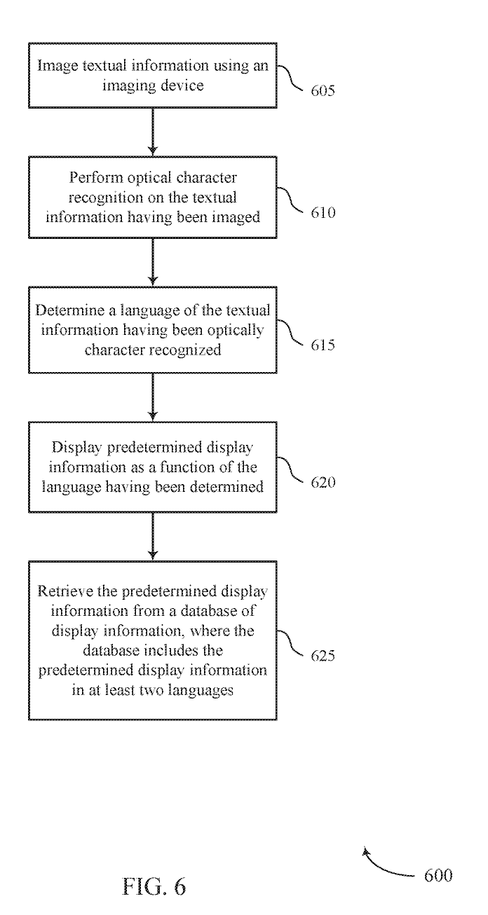

FIG. 6 shows a flowchart 600 of a process for setting a language configuration of a printing device based on a source document in accordance with aspects of the present disclosure. In some examples, an image capture device may execute a set of codes to control functional elements of the image capture device to perform the described functions. Additionally, or alternatively, an image capture device may use special-purpose hardware.

At block 605 the image capture device may image textual information using an imaging device. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 610 the image capture device may perform optical character recognition on the textual information having been imaged. These operations may be performed according to the methods and processes described in accordance with aspects of the present disclosure. For example, the operations may be composed of various substeps, or may be performed in conjunction with other operations described herein. In certain examples, aspects of the described operations may be performed by optical character recognizer 215 as described with reference to FIG. 2. In some cases, this function may be performed by an external device connected to the image capture device via a network connection.

At block 615 the image capture device may determine a language of the textual information having been optically character recognized. These operations may be performed according to the methods and processes described in accordance with aspects of the present disclosure. For example, the operations may be composed of various substeps, or may be performed in conjunction with other operations described herein. In certain examples, aspects of the described operations may be performed by language identifier 220 as described with reference to FIG. 2. In some cases, this function may be performed by an external device connected to the image capture device via a network connection.

At block 620 the image capture device may display predetermined display information as a function of the language having been determined. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

At block 625 the image capture device may retrieve the predetermined display information from a database of display information, where the database includes the predetermined display information in at least two languages. These operations may be performed according to the methods and processes described in accordance with aspects of the present disclosure. For example, the operations may be composed of various substeps, or may be performed in conjunction with other operations described herein. In certain examples, aspects of the described operations may be performed by database component 265 as described with reference to FIG. 2. In some cases, this function may be performed by an external device connected to the image capture device via a network connection.

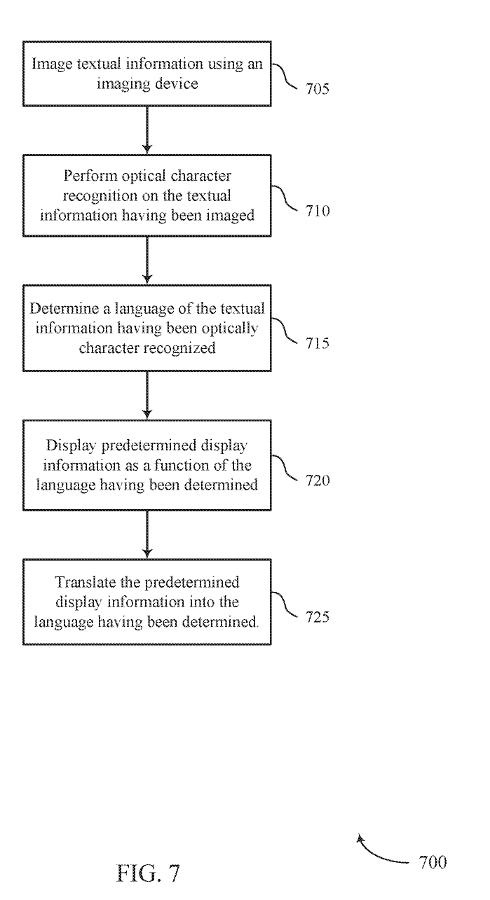

FIG. 7 shows a flowchart 700 of a process for setting a language configuration of a printing device based on a source document in accordance with aspects of the present disclosure. In some examples, an image capture system may execute a set of codes to control functional elements of the image capture system to perform the described functions. Additionally, or alternatively, an image capture system may use special-purpose hardware.

At block 705 the image capture system may image textual information using an imaging device. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 710 the image capture system may perform optical character recognition on the textual information having been imaged. These operations may be performed according to the methods and processes described in accordance with aspects of the present disclosure. For example, the operations may be composed of various substeps, or may be performed in conjunction with other operations described herein. In certain examples, aspects of the described operations may be performed by optical character recognizer 215 as described with reference to FIG. 2. In some cases, this function may be performed by an external device connected to the image capture device via a network connection.

At block 715 the image capture system may determine a language of the textual information having been optically character recognized. These operations may be performed according to the methods and processes described in accordance with aspects of the present disclosure. For example, the operations may be composed of various substeps, or may be performed in conjunction with other operations described herein. In certain examples, aspects of the described operations may be performed by language identifier 220 as described with reference to FIG. 2. In some cases, this function may be performed by an external device connected to the image capture device via a network connection.

At block 720 the image capture system may display predetermined display information as a function of the language having been determined. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

At block 725 the image capture system may translate the predetermined display information into the language having been determined. These operations may be performed according to the methods and processes described in accordance with aspects of the present disclosure. For example, the operations may be composed of various substeps, or may be performed in conjunction with other operations described herein. In certain examples, aspects of the described operations may be performed by translation service 125 as described with reference to FIG. 1. In some cases, this function may be performed by an external device connected to the image capture device via a network connection.

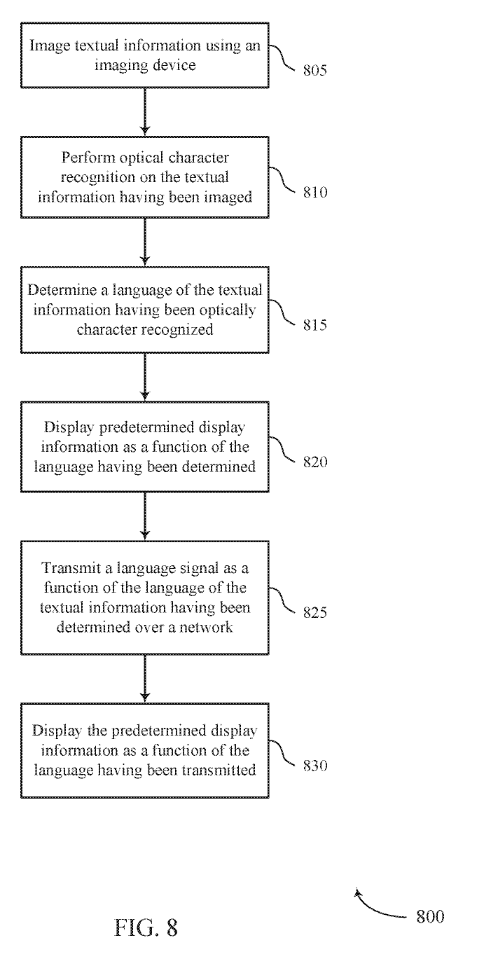

FIG. 8 shows a flowchart 800 of a process for setting a language configuration of a printing device based on a source document in accordance with aspects of the present disclosure. In some examples, an image capture device may execute a set of codes to control functional elements of the image capture device to perform the described functions. Additionally, or alternatively, an image capture device may use special-purpose hardware.

At block 805 the image capture device may image textual information using a imaging device. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 810 the image capture device may perform optical character recognition on the textual information having been imaged. These operations may be performed according to the methods and processes described in accordance with aspects of the present disclosure. For example, the operations may be composed of various substeps, or may be performed in conjunction with other operations described herein. In certain examples, aspects of the described operations may be performed by optical character recognizer 215 as described with reference to FIG. 2. In some cases, this function may be performed by an external device connected to the image capture device via a network connection.

At block 815 the image capture device may determine a language of the textual information having been optically character recognized. These operations may be performed according to the methods and processes described in accordance with aspects of the present disclosure. For example, the operations may be composed of various substeps, or may be performed in conjunction with other operations described herein. In certain examples, aspects of the described operations may be performed by language identifier 220 as described with reference to FIG. 2. In some cases, this function may be performed by an external device connected to the image capture device via a network connection.

At block 820 the image capture device may display predetermined display information as a function of the language having been determined. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

At block 825 the image capture device may transmit a language signal as a function of the language of the textual information having been determined over a network. These operations may be performed according to the methods and processes described in accordance with aspects of the present disclosure. For example, the operations may be composed of various substeps, or may be performed in conjunction with other operations described herein. In certain examples, aspects of the described operations may be performed by network communication unit 240 as described with reference to FIG. 2. In some cases, this function may be performed by an external device connected to the image capture device via a network connection.

At block 830 the image capture device may display the predetermined display information as a function of the language having been transmitted. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

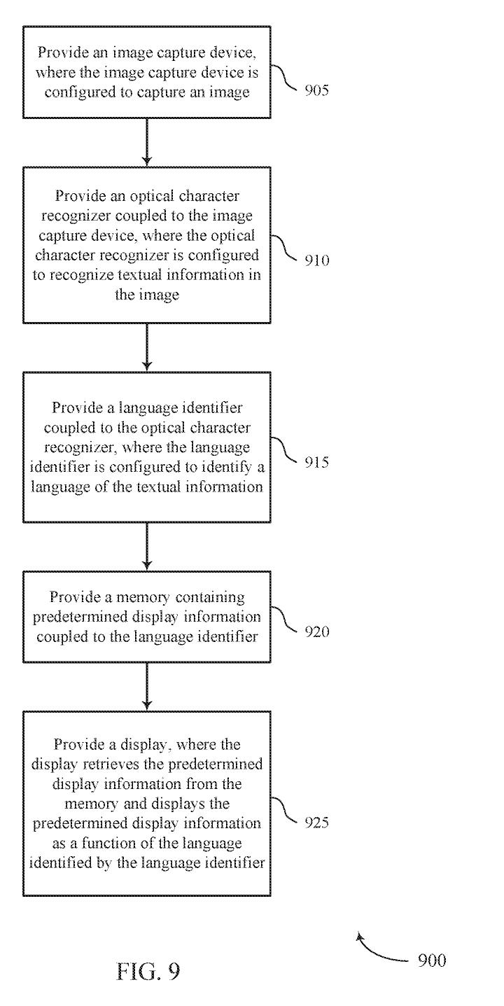

FIG. 9 shows a flowchart 900 of a process for setting a language configuration of a printing device based on a source document in accordance with aspects of the present disclosure. In some examples, a system may execute a set of codes to control functional elements of the system to perform the described functions. Additionally, or alternatively, a system may use special-purpose hardware.

At block 905 the system may provide an image capture device, where the image capture device is configured to capture an image. These operations may be performed according to the methods and processes described in accordance with aspects of the present disclosure. For example, the operations may be composed of various substeps, or may be performed in conjunction with other operations described herein. In certain examples, aspects of the described operations may be performed by image capture device 110 and 205 as described with reference to FIGS. 1 and 2.

At block 910 the system may provide an optical character recognizer coupled to the image capture device, where the optical character recognizer is configured to recognize textual information in the image. These operations may be performed according to the methods and processes described in accordance with aspects of the present disclosure. For example, the operations may be composed of various substeps, or may be performed in conjunction with other operations described herein. In certain examples, aspects of the described operations may be performed by optical character recognizer 215 as described with reference to FIG. 2.

At block 915 the system may provide a language identifier coupled to the optical character recognizer, where the language identifier is configured to identify a language of the textual information. These operations may be performed according to the methods and processes described in accordance with aspects of the present disclosure. For example, the operations may be composed of various substeps, or may be performed in conjunction with other operations described herein. In certain examples, aspects of the described operations may be performed by language identifier 220 as described with reference to FIG. 2.

At block 920 the system may provide a memory containing predetermined display information coupled to the language identifier. These operations may be performed according to the methods and processes described in accordance with aspects of the present disclosure. For example, the operations may be composed of various substeps, or may be performed in conjunction with other operations described herein. In certain examples, aspects of the described operations may be performed by memory 255 as described with reference to FIG. 2.

At block 925 the system may provide a display, where the display retrieves the predetermined display information from the memory and displays the predetermined display information as a function of the language identified by the language identifier. These operations may be performed according to the methods and processes described in accordance with aspects of the present disclosure. For example, the operations may be composed of various substeps, or may be performed in conjunction with other operations described herein. In certain examples, aspects of the described operations may be performed by display 230 as described with reference to FIG. 2.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for displaying information on a display, comprising:
imaging textual information using an image capture device;
performing optical character recognition on the textual information having been imaged;
determining a language of the textual information having been optically character recognized; and
displaying predetermined display information as a function of the language having been determined.

2. The method of claim 1, further comprising:
prompting a user in response to the determining said language to provide a user input; and
receiving the user input in response to the prompting of the user;
wherein the displaying predetermined display information is in response to the receiving the user input.

3. The method of claim 2, wherein:
the prompting said user comprises displaying said language having been determined to said user and requesting that said user confirm said language having been determined.

4. The method of claim 1, further comprising:
retrieving said predetermined display information from a database of display information, wherein said database includes said predetermined display information in at least two languages.

5. The method of clam 4, wherein:
said retrieving comprises transmitting a request for said predetermined display information via a network and receiving said predetermined display information via the network.

6. The method of claim 1, further comprising:
translating said predetermined display information into said language having been determined.

7. The method of claim 1, further comprising:
transmitting a language signal as a function of said language of the textual information having been determined over a network; and
displaying said predetermined display information as a function of the language having been transmitted.

8. The method of claim 1, further comprising:
maintaining a database including said predetermined display information in at least two languages.

9. A system comprising:
an image capture device, wherein the image capture device is configured to capture an image;
an optical character recognizer coupled to the image capture device, wherein the optical character recognizes is configured to recognize textual information in the image;
a language identifier coupled to the optical character recognizer, wherein the language identifier is configured to identify a language of the textual information;
a memory containing predetermined display information coupled to the language identifier; and
a display, wherein the display retrieves the predetermined display information from the memory and displays the predetermined display information as a function of the language identified by the language identifier.

10. The system of claim 9, wherein:
said image capture device comprises a camera.

11. The system of claim 9, wherein:
said image capture device comprises a scanner.

12. The system of claim 9, further comprising:
an input device coupled to the memory, wherein said input device is a touch screen.

13. The system of claim 9, wherein:
said display displays a confirmation prompt in response to said language having been identified by said language identifier, wherein said input device receives a confirmation input in response to said confirmation prompt, and wherein said display displays said predetermined display information as a function of said language identified by the language identifier and the confirmation input received by said input device.

14. The system of claim 9, further comprising:
a network, wherein said memory is coupled to said language identifier via the network.

15. An apparatus comprising:
an optical character recognizer coupled to an image capture device, wherein the optical character recognizer is configured to recognize textual information in the image;
a language identifier coupled to the optical character recognizer, wherein the language identifier is configured to identify a language of the textual information;
a memory containing predetermined display information coupled to the language identifier; and
a display, wherein the display retrieves the predetermined display information from the memory and displays the predetermined display information as a function of the language identified by the language identifier.

16. The apparatus of claim 15, further comprising:
a camera.

17. The apparatus of claim 15, further comprising:
a scanner.

18. The apparatus of claim 15, further comprising:
an input device coupled to the memory, wherein said input device is a touch screen.

19. The apparatus of claim 15, wherein:
said display displays a confirmation prompt in response to said language having been identified by said language identifier, wherein said input device receives a confirmation input in response to said confirmation prompt, and wherein said display displays said predetermined display information as a function of said language identified by the language identifier and the confirmation input received by said input device.
